(19) United States
(12) Patent Application Publication
(10) Pub. No.: US 2017/0160858 A1
(43) Pub. Date: Jun. 8, 2017

(54) INTEGRATED TOUCH CONTROL DISPLAY PANEL AND TOUCH DISPLAY DEVICE

(71) Applicants: Shanghai AVIC OPTO Electronics Co., Ltd., Shanghai (CN); Tianma Micro-electronics Co., Ltd., Shenzhen (CN)

(72) Inventors: SHOUFU JIAN, Shanghai (CN); ZHAOKENG CAO, Shanghai (CN); FENG QIN, Shanghai (CN); ZHIQIANG XIA, Shanghai (CN); YANLI WANG, Shanghai (CN); LINA SUN, Shanghai (CN)

(73) Assignees: Shanghai AVIC OPTO Electronics Co., Ltd.; Tianma Micro-electronics Co., Ltd.

(21) Appl. No.: 15/162,111

(22) Filed: May 23, 2016

(30) Foreign Application Priority Data
Dec. 7, 2015 (CN) 2015-10897262.7

(51) Int. Cl. G06F 3/041; G09G 3/36; G02F 1/1362; G02F 1/1335; G02F 1/1343; G02F 1/1368; G06F 3/044; G02F 1/1333

(52) U.S. Cl. CPC G06F 3/0416; G06F 3/044; G06F 3/0412; G09G 3/3677; G09G 3/3688; G09G 3/3696; G02F 1/13338; G02F 1/133514; G02F 1/134309; G02F 1/1368; G02F 1/136286; G09G 2300/0809; G09G 2310/0278; G09G 2310/0202; G06F 2203/04103

(57) ABSTRACT

The present disclosure provides an integrated touch control display panel. The integrated touch control display panel includes a first substrate, a plurality of data lines configured on the first substrate, which are sequentially arranged in a first direction and extend in a second direction intersecting the first direction, and a plurality of stripe-shaped touch control electrodes sequentially arranged in the first direction and extends in the second direction. The plurality of the data lines supply display signals to a plurality of display pixels. In a direction vertical to the first substrate, at least one stripe-shaped touch control electrode overlaps with N number of data lines, N being an even natural number. During a touch control phase, the N number of the data lines are divided into equal number of data lines carrying positive display driving voltages and data lines carrying negative display driving voltages.

### CROSS-REFERENCES TO RELATED APPLICATIONS

This application claims the priority of Chinese Patent Application No. CN201510897262.7, filed on Dec. 7, 2015, the entire contents of which are incorporated herein by reference.

### FIELD OF THE DISCLOSURE

The present disclosure generally relates to the touch control technologies and, more particularly, relates to an integrated touch control display panel and a touch display device.

### BACKGROUND

With the advancement of modern electronic technologies, the display panel of display device may incorporate additional structures to support more functions. For example, touch control structure may be incorporated to support touch control function to provide users with application convenience.

Currently, to reduce the thickness of display panel and support touch control function at the same time, touch control structure is often integrated into display panel. When the capacitive touch control structure is used, the touch control electrodes of the capacitive touch control structure may be directly formed on the same substrate as the display structure. However, such configuration may cause certain issues. In the display panel operation, the display structure and the touch control structure may receive complex and varying electrical signals. These electrical signals may interfere with one another to affect the touch control performance and the display performance of the integrated touch control display panel.

The disclosed integrated touch control display panel and touch display device are directed to solve one or more problems in the art.

### BRIEF SUMMARY OF THE DISCLOSURE

Directed to solve one or more problems set forth above and other problems in the art, the present disclosure provides an integrated touch control display panel and a touch display device.

One aspect of the present disclosure includes an integrated touch control display panel. The integrated touch control display panel includes a first substrate, a plurality of data lines configured on the first substrate, which are sequentially arranged in a first direction and extend in a second direction intersecting the first direction, and a plurality of stripe-shaped touch control electrodes sequentially arranged in the first direction and extends in the second direction. The plurality of the data lines supply display signals to a plurality of display pixels. In a direction vertical to the first substrate, at least one stripe-shaped touch control electrode overlaps with N number of data lines, N being an even natural number. During a touch control phase, the N number of the data lines are divided into equal number of data lines carrying positive display driving voltages and data lines carrying negative display driving voltages.

Another aspect of the present disclosure includes a touch display device. The touch display device includes the disclosed integrated touch control display panel.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic view of an exemplary touch display device according to the disclosed embodiments;

FIG. 2 illustrates a top view of an exemplary integrated touch control display panel according to the disclosed embodiments;

FIG. 3 illustrates a close-up view of an exemplary integrated touch control display panel according to the disclosed embodiments;

FIG. 4 illustrates a close-up view of another exemplary integrated touch control display panel according to the disclosed embodiments;

FIG. 5 illustrates a top view of touch control electrodes of an exemplary integrated touch control display panel according to the disclosed embodiments;

FIG. 6 illustrates a schematic view of an exemplary mutual capacitance mode touch control structure according to the disclosed embodiments;

FIG. 7 illustrates a cross-sectional view along the CD line in FIG. 6;

FIG. 8 illustrates another cross-sectional view along the CD line in FIG. 6; and

FIG. 9 illustrates a close-up view of another exemplary integrated touch control display panel according to the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It should be understood that the exemplary embodiments described herein are only intended to illustrate and explain the present invention and not to limit the present invention.

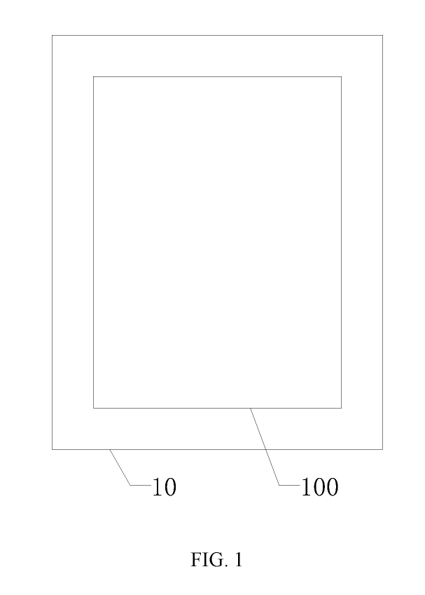

FIG. 1 illustrates a schematic view of an exemplary touch display device according to the present disclosure. Referring to FIG. 1, the touch display device 10 may include an integrated touch control display panel 100 and other components to support the operation of the integrated touch control display panel 100. The touch display device may be a smart phone, a desktop computer, a laptop computer, and an electronic photo album, etc. The integrated touch control display panel 100 may include touch control structure and display structure configured on a same substrate to support both image display and touch control functions.

Such integration may reduce the number of substrates and the thickness of the integrated touch control display panel. As a result, the integrated touch control display panel may not only have the convenient touch control function, but also have the advantages of compact dimension and light weight. On the other hand, the integration of the touch control structure and the display structure on the same substrate may bring other issues and obstacles. For the touch display device according to the present disclosure, improvements have been made to the integrated touch control panel 100 to increase the reliability. The integrated touch control display panel 100 according to the present disclosure is described in detail below.

The integrated touch control display panel 100 may include a substrate and a plurality of data lines. The plurality of the data lines may supply display driving voltages to pixel electrodes. The plurality of the data lines may be sequentially arranged in a first direction, and may extend in a second direction intersecting the first direction. In a direction vertical to substrate, at least one touch control electrode may overlap with N number of data lines, wherein N is a natural number. During a touch control phase, the N number of the data lines may have an equal number of positive data lines and negative data lines carrying the corresponding display driving voltages.

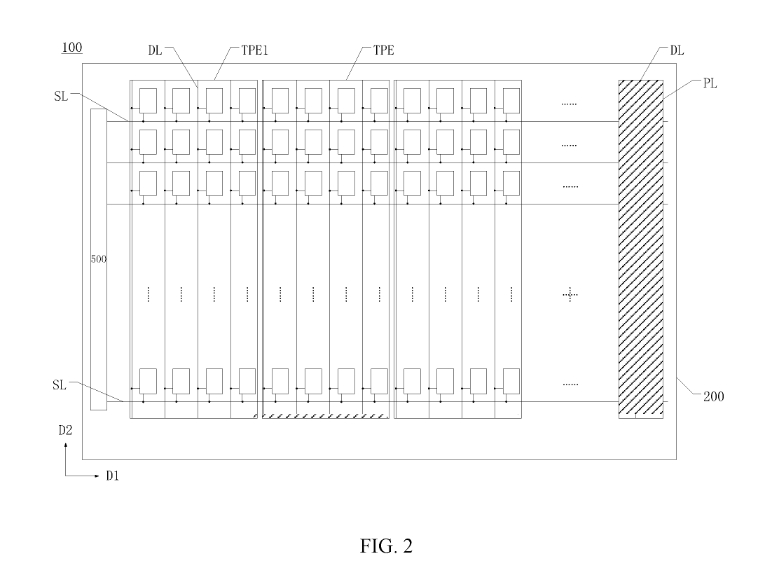

FIG. 2 illustrates a top view of an exemplary integrated touch control display panel according to the present disclosure. Referring to FIG. 2, the integrated touch control display panel 100 may include a substrate 200 and a plurality of data lines DL configured on the substrate 200. The plurality of the data lines DL may supply display signals to display pixels PL.

The data lines DL may be sequentially arranged in a first direction D1, and may extend in a second direction D2 intersecting the first direction. In a direction vertical to the substrate 200, at least one touch control electrode TPE may overlap with the N number of the data lines DL. N is a natural number.

In one embodiment, for example, in the direction vertical to the substrate 200, the touch control electrode TPE1 may overlap with four data lines DL. During the touch control phase, the four data lines DL overlapped by the touch control electrode TPE1 may have an equal number of the data lines DL carrying positive display driving voltages and the data lines DL carrying negative display driving voltages. In this case, the number of the positive data lines DL and the number of the negative data lines DL may be 2. The configuration shown in FIG. 2 may be only for illustration purpose. Other appropriate configurations may be used in real product designs as long as the number of the data lines DL carrying the positive display driving voltages and the number of the data lines DL carrying the negative display driving voltages are equal.

Due to the coupling between the data lines DL and the touch control electrode TPE, the display driving voltages carried by the data lines DL may interfere with the signals carried by the touch control electrodes TPE. When the touch control electrodes TPE operate as touch control driving electrodes, touch control driving signals may be supplied to the touch control driving electrodes during the touch control phase. The touch control driving signals may often be pulsed signals. The display driving voltages carried by the data lines DL may affect and destabilize the touch control driving signals.

When the touch control electrodes TPE operate as touch control detecting electrodes, touch control detecting signals may be received by the touch control detecting electrodes during the touch control phase. The touch control detecting signals may often be pulsed signals. The display driving voltages carried by the data lines DL may affect the touch control detecting signals and may cause the touch control detecting signals to represent the touch control status incorrectly. Ultimately, the display driving voltages carried by the data lines DL may affect both the touch control driving signals and the touch control detecting signals and may reduce touch control result precision.

In the integrated touch control display panel 100 according to the present disclosure, the data lines DL that overlap with the touch control electrodes TPE during the touch control phase may be configured such that the number of the data lines DL carrying the positive display voltages and the number of the data lines DL carrying the negative display voltages may be equal. To certain extent, the positive display driving voltages and the negative display driving voltages carried by the equal number of the data lines DL may cancel out with one another. The interferences to the touch control signals carried by the touch control electrodes TPE by the display driving voltages carried by the data lines may be minimized substantially. Thus, the touch control noise may be reduced and the touch control precision may be improved.

A polarity inversion method may be used to drive display pixel array in liquid crystal display to avoid the presence of liquid crystal residual DC. The polarity inversion of the display pixel array may often include frame inversion, column inversion, row inversion, and dot inversion. Further, the polarity inversion may also include two-dot inversion, two-column inversion, and two-row inversion, etc.

For example, the dot inversion or the row inversion method may supply display driving voltages with different polarities to the data lines DL at the same time. One row of the data lines DL may be supplied with display driving voltages in one polarity and the adjacent row may be supplied with display driving voltages in the opposite polarity. The positive and negative display driving voltages may be supplied to rows of the data lines DL alternately. The polarity inversion display driving method may be used in the integrated touch control display panel 100 to separate the data lines DL overlapping with the touch control electrodes TPE into equal number of positive and negative data lines DL that carry the positive and negative display driving voltages. Thus, the touch control precision of the integrated touch control display panel may be improved.

The touch control electrodes TPE of the integrated touch control display panel 100 may be in a stripe shape. The stripe-shaped touch control electrodes TPE may be sequentially arranged such that gaps may exist between the stripe-shaped touch control electrodes TPE. Optionally, in a direction vertical to the substrate 200, the gaps between adjacent stripe-shaped touch control electrodes TPE may not overlap with the data lines DL.

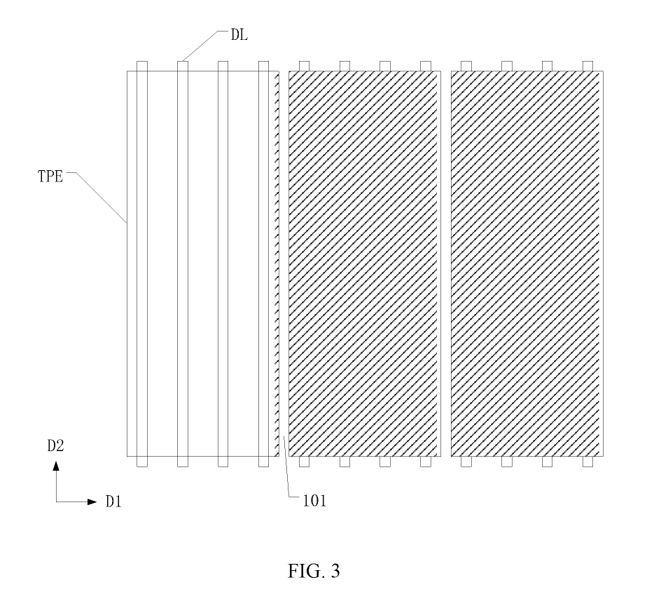

FIG. 3 illustrates a close-up view of an exemplary integrated touch control display panel according to the present disclosure. Referring to FIG. 3, a gap 101 may be located between adjacent touch control electrodes TPE. In the direction vertical to the substrate, the gaps 101 may not overlap with the data lines DL.

In one embodiment, the touch control electrodes TPE may entirely overlap with the data lines DL in the direction vertical to the substrate such that each data line DL may have equivalent interfering effect to the touch control electrode TPE. The data line DL carrying the positive display driving voltage may completely cancel out the interference caused by the data line DL carrying the negative display driving voltage. Thus, the touch control precision may be improved substantially for the integrated touch control display panel.

In another embodiment, the gaps between adjacent touch control electrodes TPE may overlap with the data lines DL in the direction vertical to the substrate. In the touch control phase, the two data lines DL that overlap with the two gaps 101 located on both sides of the touch control electrode TPE may be supplied with the display driving voltages with opposite polarities.

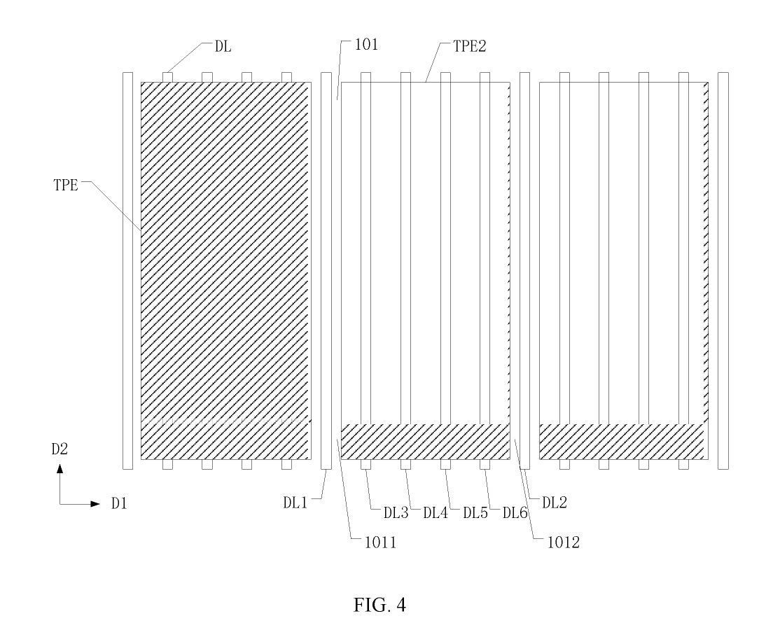

FIG. 4 illustrates a close-up view of another exemplary integrated touch control display panel according to the present disclosure. Referring to FIG. 4, gaps 101 may be configured between adjacent touch control electrodes TPE. In the direction vertical to the substrate, the gaps 101 between adjacent touch control electrodes TPE may overlap with the data lines DL. As shown in FIG. 4, the data lines DL may entirely overlap with the gaps 101. In certain other embodiments, the data lines DL may partially overlap with the gaps 101. During the touch control phase, the two data lines DL that overlap with the two gaps 101 located on both sides of one touch control electrode TPE may be supplied with the display driving voltages with opposite polarities.

Specifically, as shown in FIG. 4, the two data lines DL that overlap with the two gaps 1011 and 1012 located on both sides of the touch control electrode TPE2 may be DL1 and DL2. During the touch control phase, the data lines DL1 and DL2 may carry the display driving voltages with opposite polarities. Further, the data lines DL3, DL4, DL5 and DL6 may also overlap with the touch control electrodes TPE. The data lines DL that entirely or partially overlap with the gaps 101 may not be counted to the number of data lines that overlap with the touch control electrodes TPE. Thus, during the touch control phase, the data lines DL3, DL4, DL5 and DL6 may be divided into equal number of the data lines DL carrying positive display driving voltages and the data lines DL carrying negative display driving voltages.

The data lines DL that overlap with the gaps 101 may have equivalent effects to the touch control electrodes TPE. A touch control electrode TPE may be affected by two adjacent data lines DL that overlap with the gaps 101 located on both sides of the touch control electrode TPE. When the two data lines DL carry the display driving voltages with opposite polarities, one of the two data lines DL carrying the positive display driving voltage may substantially cancel out the interference caused by the other of the two data lines DL carrying the negative display driving voltage. Thus, the touch control precision may be improved substantially for the integrated touch control display panel.

Optionally, a plurality of slots may be configured on the touch control electrodes. For example, a touch control electrode may be overlapped by N number of data lines. M out of N number of data lines may overlap with the slots configured on the touch control electrode. During the touch control phase, M number of the data lines may be divided into equal number of the data lines carrying positive display driving voltages and the data lines carrying negative display driving voltages. M and N are natural numbers. M≦N.

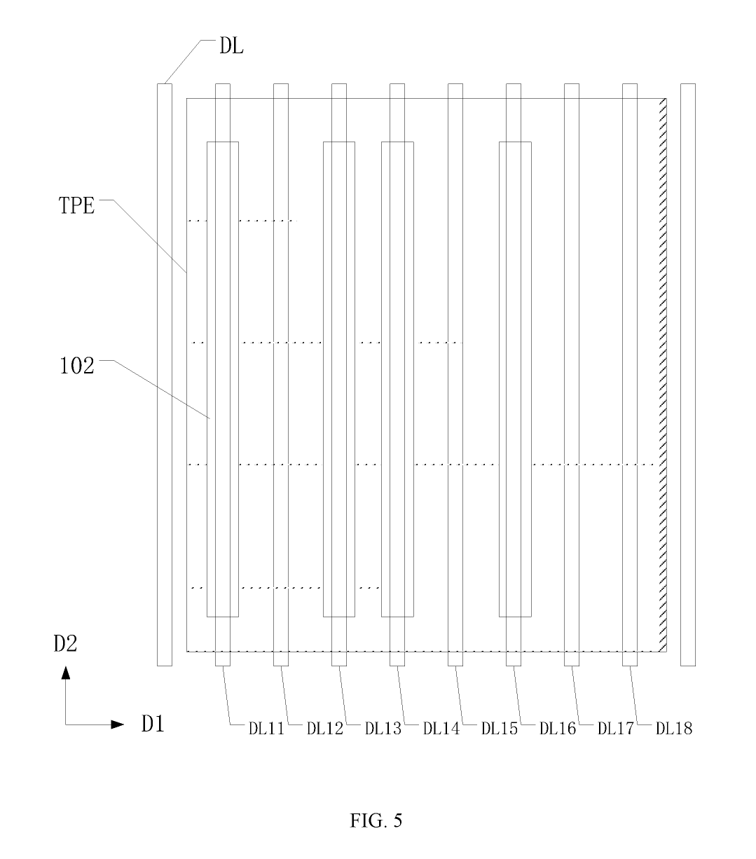

FIG. 5 illustrates a top view of touch control electrodes of an exemplary integrated touch control display panel according to the present disclosure. Referring to FIG. 5, a touch control electrode TPE may be overlapped by eight data lines DL in the direction vertical to the substrate. That is, the touch control electrode TPE may be overlapped by the eight data lines DL11, DL12, DL13, DL14, DL15, DL16, DL17 and DL18. During the touch control phase, the eight data lines DL11, DL12, DL13, DL14, DL15, DL16, DL17 and DL18 may be divided into equal number of the data lines carrying positive display driving voltages and the data lines carrying negative display driving voltages.

A plurality of slots 102 may be configured on the touch control electrode TPE. The slots 102 may be overlapped by four data lines DL11, DL13, DL14 and DL16. During the touch control phase, the data lines DL11, DL13, DL14 and DL16 may be divided into equal number of the data lines carrying positive display driving voltages and the data lines carrying negative display driving voltages.

The slots configured on the touch control electrodes may minimize the interference caused by the data lines to the touch control electrode. In order to let the data lines carrying positive display driving voltages effectively cancel out the interference caused by the data lines carrying negative display driving voltages to the touch control electrode, separate consideration may taken whether to configure slots in the locations corresponding to the data lines and whether to divide the data lines into equal number of the data lines carrying positive display driving voltages and the data line carrying negative display driving voltages. Thus, the touch control precision may be improved substantially for the integrated touch control display panel.

Optionally, the integrated touch control display panel may also include a common electrode layer. The common electrode layer may include a plurality of stripe-shaped sub-electrodes that are insulated from one another. The sub-electrodes may be sequentially arranged in a first direction, and may extend in a second direction intersecting the first direction.

Specifically, referring to FIG. 2, the integrated touch control display panel 100 may include a plurality of display pixels PL. Each display pixel PL may include a pixel electrode, a common electrode, and a thin film transistor. The pixel electrode may be electrically connected to a drain electrode of the thin film transistor. A source electrode of the thin film transistor may be electrically connected to a data line DL. A gate electrode of the thin film transistor may be electrically connected to a scanning line SL. The scanning line SL may receive a scanning signal produced by a scanning driver circuit 500 to control the on/off state of the thin film transistor.

The scanning line SL may control whether the display driving voltage carried by the data line DL is fed to the display pixel. The pixel electrode may receive a display signal. The common electrode may receive a common signal. An electric field may be formed between the pixel electrode and the common electrode in the display pixel to control the rotation of liquid crystals to display images.

Generally, the common electrode in each display pixel may receive a same common signal. As such, the common electrodes in the display pixels of the entire display panel may be connected together to form a common electrode layer.

The integrated touch control display panel according to the present disclosure may include a common electrode layer. The common electrode layer may include a plurality of stripe-shaped sub-electrodes that are insulated from one another. The stripe-shaped sub-electrodes may be obtained by dividing the common electrode layer. A stripe-shaped sub-electrode may operate as a common electrode for a plurality of display pixels. At the same time, the stripe-shaped sub-electrodes may also operate as touch control electrodes.

When the stripe-shaped sub-electrodes operate as the touch control electrodes, the integrated touch control display panel may operate in a display state and a touch control state. The display state and the touch control state may be time multiplexed. During the display phase, the display panel may operate in the display state. During the touch control phase, the display panel may operate in the touch control state. The display phase and the touch control phase may be independent of each other.

Specifically, the display state may be a normal state for the integrated touch control display panel. During the display phase, the stripe-shaped sub-electrodes may be supplied with common signals or may be connected to ground. During the touch control phase, the display state may be suspended, and the stripe-shaped sub-electrodes may send touch control driving signals or receive touch control detecting signals.

The stripe-shaped sub-electrodes operated as the touch control electrodes may simplify the fabrication process of the integrated touch control display panels, save manufacturing time and cost. Further, when the touch control electrodes are configured separately in the integrated touch control display panel, additional insulating layers may be formed to prevent the touch control electrodes from being interfered by other structures. Thus, the stripe-shaped sub-electrodes operated as the touch control electrodes may simplify the layering structures of the integrated touch control display panel, and may reduce the thickness of the integrated touch control display panel.

The integrated touch control display panel may include a mutual capacitance mode touch control function. Referring to FIG. 2, the common electrode layer may include a plurality of stripe-shaped sub-electrodes TPE. The stripe-shaped sub-electrodes may operate as the touch control electrodes TPE. The stripe-shaped sub-electrodes and the touch control electrodes TPE may be multiplexed as the same electrodes. The stripe-shaped sub-electrodes may be sequentially arranged in the first direction and may extend in the second direction intersecting the first direction.

As shown in FIG. 2, one stripe-shaped sub-electrode may correspond to a plurality of the display pixels PL. Thus, one stripe-shaped sub-electrode may operate as the common electrode for the plurality of the display pixels PL. The stripe-shaped sub-electrodes may operate as either the touch control driving electrodes or the touch control detecting electrodes in the mutual capacitance touch control mode. In the mutual capacitance touch control mode, a touch control driving electrode and a touch control detecting electrode may form a capacitor.

When a touch event occurs on the integrated touch control display panel, the coupling between the touch control driving electrode and the touch control detecting electrode near the touch position may be affected. Subsequently, the capacitance between the touch control driving electrode and the touch control detecting electrode may change. The touch position may be detected and calculated as follows. The touch control driver circuit (not shown) may sequentially send touch control driving signals to the touch control driving electrodes. The touch control detection circuit (not shown) may receive the touch control detecting signals from the touch control detecting electrodes. The capacitances between the touch control driving electrodes and the touch control detecting electrodes at each and every intersection may be derived from the received touch control detecting signals. That is, the capacitance distributed over the entire surface of the integrated touch control display panel may be obtained. Based on the changes of the capacitance distribution over the integrated touch control display panel, a coordinate of the touch position may be calculated.

Optionally, the stripe-shaped sub-electrodes may operate as the touch control driving electrodes. The integrated touch control display panel may also include another substrate configured facing toward the array substrate. The generally, such substrate may also provide the color filtering function and may be called color filter substrate. The touch control detecting electrodes may be configured on the color filter substrate.

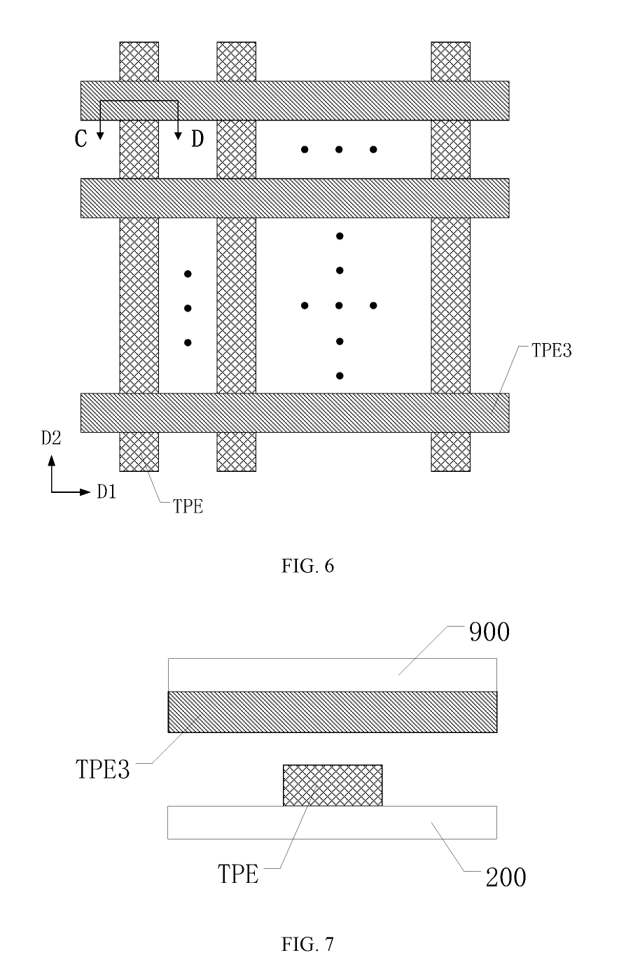

FIG. 6 illustrates a schematic view of an exemplary mutual capacitance mode touch control structure according to the present disclosure. Referring to FIG. 6, the stripe-shaped sub-electrodes TPE may operate as the touch control driving electrodes. During the touch control phase, the touch control driving signals may be supplied to the stripe-shaped sub-electrodes TPE. Accordingly, the integrated touch control display panel may also include a plurality of sequentially arranged stripe-shaped touch control detecting electrodes TPE3.

The stripe-shaped touch control detecting electrodes TPE3 may extend in the first direction Dl. The extension direction of the stripe-shaped touch control detecting electrodes TPE3 may intersect with the extension direction D2 of the touch control driving electrodes, i.e., the stripe-shaped sub-electrodes TPE. The stripe-shaped touch control detecting electrodes TPE3 may be arranged in parallel. The stripe-shaped touch control electrodes TPE3 may be used to receive the touch control detecting signals. That is, the stripe-shaped touch control detecting electrodes TPE3 may operate as the touch control detecting electrodes.

Further, the stripe-shaped sub-electrodes TPE and the stripe-shaped touch control detecting electrodes TPE3 may have other configurations, such as the following two configurations.

FIG. 7 illustrates a cross-sectional view along the CD line in FIG. 6. Referring to FIG. 7, a stripe-shaped sub-electrode TPE may be configured on the substrate 200. The integrated touch control display panel according to the present disclosure may also include a substrate 900 configured facing toward the substrate 200. A stripe-shaped touch control detecting electrode TPE3 may be configured on the substrate 900. Data lines (not shown) and a common electrode layer (not shown) may be configured on the side of the substrate 200 facing toward the substrate 900. The stripe-shaped touch control detecting electrode TPE3 may be configured on the side of the substrate 900 facing toward the substrate 200. A liquid crystal layer (not shown) may be sandwiched between the substrate 200 and the substrate 900.

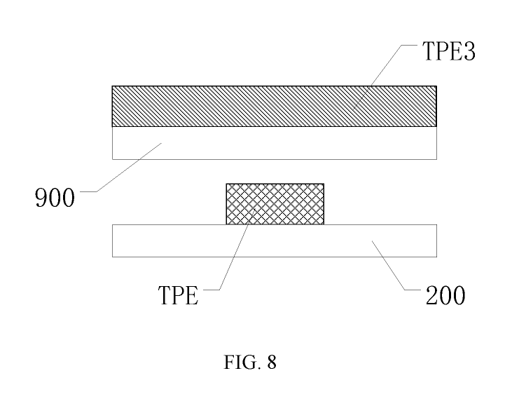

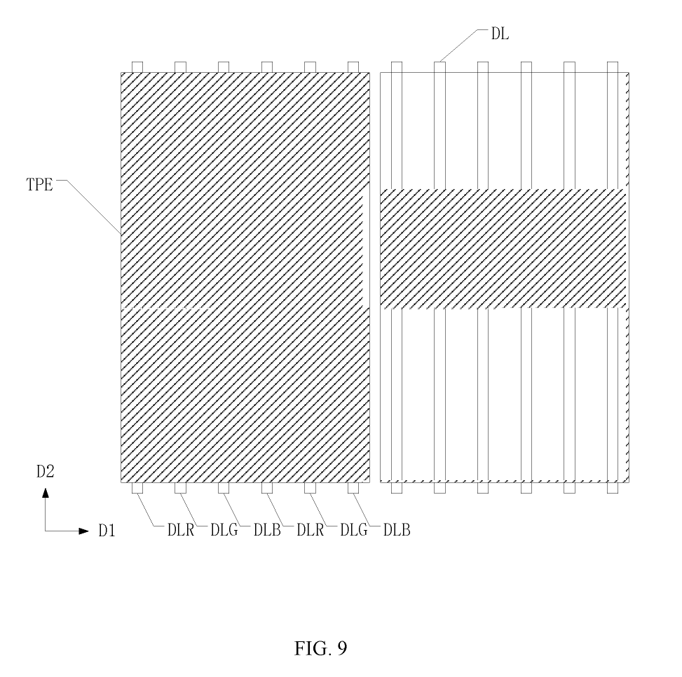

FIG. 8 illustrates another cross-sectional view along the CD line in FIG. 6. Referring to FIG. 8, a stripe-shaped sub-electrode TPE may be configured on the substrate 200. The integrated touch control display panel according to the present disclosure may also include a substrate 900 configured facing toward the substrate 200. A stripe-shaped touch control detecting electrode TPE3 may be configured on the substrate 900. Compared to FIG. 7, the stripe-shaped touch control detecting electrode TPE3 may be configured on the side of the substrate 900 facing away from the substrate 200. Data lines (not shown) and a common electrode layer (not shown) may be configured on the side of the substrate 200 facing toward the substrate 900. A liquid crystal layer (not shown) may be sandwiched between the substrate 200 and the substrate 900.

In certain embodiment, the stripe-shaped touch control detecting electrode may be configured on the side of the substrate facing away from the array substrate. When the substrate facing toward the array substrate is present, touch operations may be performed on the side of the substrate facing away from the array substrate. Therefore, when the stripe-shaped touch control detecting electrode is configured on the side of the substrate facing away from the array substrate, the stripe-shaped touch control detecting electrode may be placed closer to the touch operation surface. The touch operation may more substantially affect the stripe-shaped touch control detecting electrode. The touch control detecting electrode may more precisely detect the touch control signal. The touch operation position may be more precisely calculated.

Preferably, the stripe-shaped touch control detecting electrode may be configured on the side of the substrate facing away from the array substrate. Thus, the touch operation position may be more precisely calculated.

During the touch control phase, N number of data lines overlapping a touch control electrode may be divided into equal number of the data lines carrying positive display driving voltages and the data lines carrying negative display driving voltages. Further, during the display phase, N number of data lines overlapping the touch control electrode may be divided into equal number of the data lines carrying positive display driving voltages and the data lines carrying negative display driving voltages.

Because the coupling between the data lines and the touch control electrode is mutually effective, the data lines may affect the touch control electrode to cause the voltage on the touch control electrode to change. In return, the voltage change on the touch control electrode may affect the data lines.

Thus, during the display phase, N number of the data lines overlapping the touch control electrode may be divided into equal number of the data lines carrying positive display driving voltages and the data lines carrying negative display driving voltages. The data lines carrying positive display driving voltages may cancel out the interference caused by the data lines carrying negative display driving voltages. The voltage on the touch control electrode may remain stable. In return, the touch control electrode may not cause the interference to the display driving voltages carried by the data lines. The display performance may be more consistent.

Specifically, when displaying some pure color dominated images, such as pure red dominated images, even if the display driving voltage polarities are the same, the display driving voltage polarity control may be effective due to the significant differences between the display driving voltages for red color display pixel, green color display pixel and blue color display pixel. The display driving voltage polarity control for same color display pixels may have more desired effect on the interference cancelation.

Thus, during the touch control phase or the display phase, N number of data lines overlapping a touch control electrode may be divided into equal number of the data lines carrying positive display driving voltages for displaying the red/green/blue color display pixels and the data lines carrying negative display driving voltages for display the red/green/blue color display pixels, respectively.

FIG. 9 illustrates a close-up view of another exemplary integrated touch control display panel according to the present disclosure. Referring to FIG. 9, six data lines DL may overlap with a touch control electrode TPE. During the touch control phase or the display phase, the six data lines may be divided into equal number of the data line carrying positive display driving voltages and the data lines carrying negative display driving voltages. Both may have three data lines.

Further, for example, as shown in FIG. 9, the touch control electrode TPE on the left side may be overlapped by six data lines DL. During the touch control phase or the display phase, the six data lines may be divided into two data lines DLR to supply display signals for displaying red color display pixels, two data lines DLG to supply display signals for displaying green color display pixels, and two data lines DLB to supply display signals for displaying blue color display pixels. The two data lines DLR may carry the display driving voltages with opposite polarities. The two data lines DLG may carry the display driving voltages with opposite polarities. The two data lines DLB may carry the display driving voltages with opposite polarities. The number of the data lines DL carrying positive display driving voltages for displaying red/green/blue color display pixels may be equal to the number of the data lines carrying negative display driving voltages for displaying red/green/blue color display pixels. Thus, the integrated touch control display panel according to the present disclosure may have more precise touch control position calculation and more consistent display performance.

Various embodiments have been described to illustrate the operation principles and exemplary implementations. The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. An integrated touch control display panel, comprising:
a first substrate;
a plurality of data lines configured on the first substrate, which are sequentially arranged in a first direction and extend in a second direction intersecting the first direction; and
a plurality of stripe-shaped touch control electrodes sequentially arranged in the first direction and extends in the second direction, wherein:
the plurality of the data lines supply display signals to a plurality of display pixels;
in a direction vertical to the first substrate, at least one stripe-shaped touch control electrode overlaps with N number of data lines, N being an even natural number; and
during a touch control phase, the N number of the data lines are divided into equal number of data lines carrying positive display driving voltages and data lines carrying negative display driving voltages.

2. The integrated touch control display panel of claim 1, wherein:
in a direction vertical to the first substrate, no data line is overlapped with gaps between adjacent stripe-shaped touch control electrodes.

3. The integrated touch control display panel of claim 1, wherein:
in a direction vertical to the first substrate, certain data lines overlap with gaps between adjacent stripe-shaped touch control electrodes; and
during the touch control phase, the data lines that overlap with the two gaps located on both sides of any stripe-shaped touch control electrode carry a display driving voltage.

4. The integrated touch control display panel of claim 1, wherein:
a plurality of slots are configured on the stripe-shaped touch control electrodes;
N number of the data lines overlap with each stripe-shaped touch control electrode in a direction vertical to the first substrate;
M number of the data lines overlap with the plurality of the gaps in the direction vertical to the first substrate;
M number of the data lines are divided into equal number of data lines carrying the positive display driving voltages and data lines carrying the negative display driving voltages;
M and N are natural number; and
M≦N.

5. The integrated touch control display panel of claim 1, further including a common electrode layer, wherein:
the common electrode layer includes a plurality of stripe-shapes sub-electrodes that are insulated from one another;
the stripe-shaped sub-electrodes are sequentially arranged in the first direction and extend in the second direction; and
the stripe-shaped sub-electrodes operate as common electrodes during a display phase and touch control electrodes during the touch control phase.

6. The integrated touch control display panel of claim 5, further including a second substrate configured facing toward the first substrate, wherein:
the stripe-shaped sub-electrodes configured on the first substrate operate as touch control driving electrodes; and
touch control detecting electrodes are configured on the second substrate to correspond to the touch control driving electrodes on the first substrate. The integrated touch control display panel of claim 6, wherein:
the data lines and the common electrode layer including the touch control driving electrodes are configured on the side of the first substrate facing toward the second substrate; and
the touch control detecting electrodes are configured on the side of the second substrate facing away from the first substrate.

8. The integrated touch control display panel of claim 6, wherein:
the touch control detecting electrodes include a plurality of stripe-shaped touch control detecting electrodes that are sequentially arranged in parallel; and
an extension direction of the stripe-shaped touch control detecting electrodes intersects with an extension direction of the touch control driving electrodes.

9. The integrated touch control display panel of claim 5, wherein:
during the display phase, N number of the data lines are divided into equal number of data lines carrying the positive display driving voltages and data lines carrying the negative display driving voltages.

10. The integrated touch control display panel of claim 1, wherein:
the N number of the data lines that overlap with the touch control electrodes in the direction vertical to the first substrate supply the display driving voltages to display pixels for red, green, and blue colors;
during the touch control phase, a total number of the data lines carrying the positive display driving voltages for displaying red, green, and blue color display pixels are equal to a total number of the data lines carrying the negative display driving voltages for displaying red/green/blue color display pixels, respectively; and
during a display phase, a total number of the data lines carrying the positive display driving voltages for displaying red, green, and blue color display pixels are equal to a total number of the data lines carrying the negative display driving voltages for displaying red, green, and blue color display pixels, respectively.

11. A touch display device including an integrated touch control display panel, the integrated touch control display panel comprising:
a first substrate;
a plurality of data lines configured on the first substrate, which are sequentially arranged in a first direction and extend in a second direction intersecting the first direction; and
a plurality of stripe-shaped touch control electrodes sequentially arranged in the first direction and extends in the second direction, wherein:
the plurality of the data lines supply display signals to a plurality of display pixels;
in a direction vertical to the first substrate, at least one stripe-shaped touch control electrode overlaps with N number of data lines, N being an even natural number; and
during a touch control phase, the N number of the data lines are divided into equal number of data lines carrying positive display driving voltages and data lines carrying negative display driving voltages.
